(19) United States
(12) Patent Application Publication
(10) Pub. No.: US 2005/0175268 A1
(43) Pub. Date: Aug. 11, 2005

(54) Device and method for lubricating bearings

(76) Inventor: Gary J. Latham, Grimsby (CA)

Correspondence Address: IRVING M. WEINER;WEINER & BURT P.C., 635 N. US-23, P.O. BOX 186, HARRISVILLE, MI, 48740, US

(21) Appl. No.: 11/048,181

(22) Filed: Feb. 1, 2005

Related U.S. Application Data
(60) Provisional application No. 60/542,214, filed on Feb. 5, 2004.

(51) Int. Cl. F16C 19/00; F16C 33/66

(52) U.S. Cl. 384/462

(57) ABSTRACT

A lubricating device and method for delivering fresh grease to a rolling element bearing in a first cavity, by by-passing all existing grease in the first cavity and in other cavities surrounding and/or leading to the rolling element bearing, and delivering fresh grease in close proximity to the rolling element bearing. A tube is disposed between the zerk fitting and the bearing to ensure delivery of the fresh new grease to the bearing.

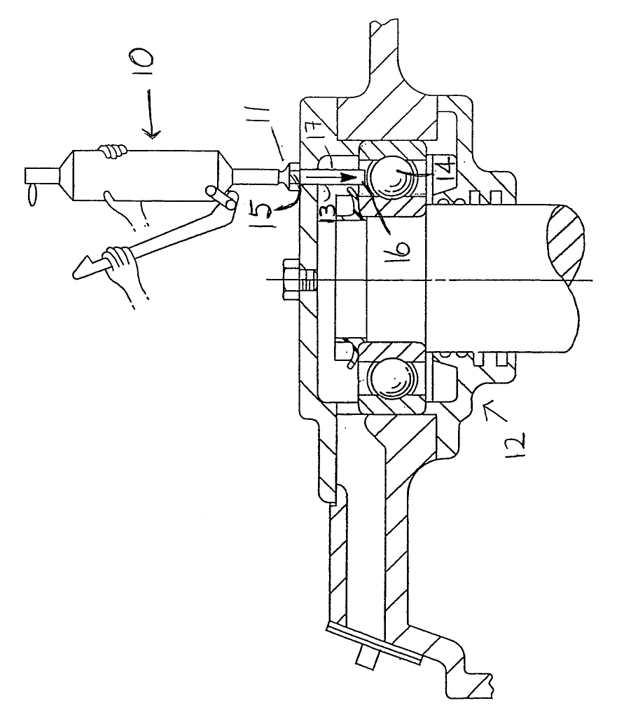

The present patent application claims priority from and is based on U.S. Provisional Patent Application Ser. No. 60/542,214 filed Feb. 5, 2004 the entire contents of which are incorporated herein by reference thereto.

The present invention relates generally to a novel and unique device and method for delivering fresh grease to rolling element bearings.

More particularly, the present invention relates to a novel and unique device and method of delivering fresh grease to rolling element bearings which will guarantee that each shot of grease reaches the bearing.

### BACKGROUND OF THE INVENTION

Heretofore, there were two basic designs of grease paths in the housings of ball and cylindrical roller bearings. The most common design entails having the grease enter a cavity on the outer side of the bearing. The other basic design is used primarily on motors where grease enters a cavity on the inner side of the bearing.

Neither of these basic design and grease methods guarantee that the grease will enter the bearing, because the grease can easily migrate out through the seals or drain plugs. This diversion of grease can be caused by many factors. The most common of such factors is hard, oxidized grease and old grease that is mostly hard soap. Old grease can also be pushed into the bearings, and thus cause damage due to lack of lubricity and suspended contamination.

In addition, a partially plugged, or rusted zerk grease fitting typically takes more than the 10,000 psi of pressure which normal grease guns can dish out. Such a situation may require the use of a high-pressure unit attached to the grease gun with which one can blast grease up to ten times the amount of pressure to unplug the most difficult zerk. Such a unit features a high-pressure chamber which fills with a normal amount of grease. If pressure builds inside the chamber due to an obstructed zerk, a 3/16″ diameter drive pin pops out. When the pin is hit with a two-pound hammer, it pounds against a 9,000 pound spring and generates up to 125,000 psi of pressure, blasting the zerk grease fitting with a presumably correct amount of grease.

The prior, but not necessarily relevant, art is exemplified by the following.

Shultz U.S. Pat. No. 4,345,667, entitled “METHOD AND APPARATUS FOR INJECTING VISCOUS MATERIALS”, discloses a method and apparatus for greasing an article such as a wheel bearing in a common vice including a housing defining an internal grease chamber including a first open end; a dished piston slideably inserted into said chamber, including threaded aperture; a stem threadably mounted in the piston aperture; and a tapered spool compression application member disposed over the stem for forcing the piston against the grease to cause the grease to pass through the piston and into the bearing.

Clark U.S. Pat. No. 5,109,955, entitled “APPARATUS FOR GREASING A WHEEL BEARING HUB”, discloses an attachment for use with a grease gun which receives grease under pressure therefrom in a reservoir, and at least three outwardly projecting circumferentially spaced nozzles carried by the attachment for dispensing the grease into and supporting a hub upon a spindle.

Sekine et al. U.S. Patent Application Publication U.S. 2001/0023795 A1, entitled “LUBRICANT APPLYING SYSTEM FOR A ROLLING BEARING”, discloses in a lubricant application system, a prescribed volume of lubricant which is transferred from a lubricant discharge port of a prescribed liquid volume discharge device to a rolling element of a rolling bearing in a state in which the lubricant discharge port is positioned directly above and sufficiently close to the rolling element, whereby the lubricant is applied to the interior of the rolling bearing. The application system inspects whether or not a prescribed volume of lubricant is injected from the discharge device for injecting a lubricant into the interior of a rolling bearing. A laser beam is irradiated between a lubricant discharge port of the lubricant discharge device and the rolling bearing, and a reflected laser beam reflected by the lubricant when it is discharged from the lubricant discharge port is received by a photoreceptor disposed on the optical axis of the reflected laser beam whereby whether or not the lubricant is applied to the rolling bearing is determined based on an output from the photoreceptor.

It is a desiderdatum of the present invention to avoid the animadversions of the conventional and prior art techniques and systems, and to provide a simple but dramatically effective new device and method for lubricating a bearing while equipment, such as motors, pumps, fans, etc. are running.

### SUMMARY OF THE INVENTION

The present invention provides a lubricating device for delivering fresh grease to a rolling element bearing in a first cavity, comprising: means for by-passing all existing grease in said first cavity and in other cavities surrounding and/or leading to said rolling element bearing, and for delivering fresh grease in close proximity to said rolling element bearing.

The present invention also provides a method for delivering fresh grease to a rolling element bearing in a first cavity, comprising the steps of: by-passing all existing grease in said first cavity and in other cavities surrounding and/or leading to said rolling element bearing; and delivering fresh grease in close proximity to said rolling element bearing.

The present invention provides a novel and unique device and method for delivering fresh grease to a bearing whereby a tube is disposed between the zerk fitting and the bearing to ensure delivery of the fresh new grease to the bearing.

It is a primary object of the present invention to provide a novel and unique device and method described hereinabove, wherein the use of this novel technique will considerably improve the life of the bearing, as well as dramatically reduce grease consumption.

Another object of the present invention is to provide a device and method as described hereinabove, which introduces an innovative and precise method of delivering fresh grease to rolling element bearings which will guarantee that each shot of new grease reaches the bearings.

Yet a further object of the present invention is to provide a novel and unique device and method as described hereinabove, wherein such device and method bypasses all existing grease in the cavity through the use of a tube which ends in close proximity to the bearing's rolling elements.

An additional object of the present invention is to provide the innovative device and method described hereinabove, wherein with every shot of grease applied, fresh grease is injected directly into the bearing rolling elements.

An additional object of the present invention is to introduce an innovative, state of the art lubrication technique which will render current methods of greasing ineffective, making existing industrial lubrication charts obsolete, and thus creating a new industry standard of lubrication excellence.

Yet a further object of the present invention is to provide a unique device and method as described hereinabove, which ensures grease lubrication is 100 percent accurate and dependable, yet using minimal amounts of grease.

The present invention possesses many advantages and features which will become more apparent to those persons skilled in this particular area of technology and to other persons when reading the detailed description of the preferred embodiments of the present invention as set forth hereinbelow in conjunction with the accompanying drawings.

### BRIEF DESCRIPTION OF THE DRAWINGS

The drawing shows a preferred embodiment of the present invention as applied and used with a bearing.

### DETAILED DESCRIPTION OF PREFERRED EMBODIMENT

With reference to the accompanying drawing, there is shown a conventional grease gun 10 being applied to a zerk grease fitting 11 of a bearing assembly 12.

The main component of the present invention comprises a tube 13 which is disposed between the zerk grease fitting 11 and the bearing rolling elements 14 to be lubricated. In accordance with the present invention, the tube 13 is affixed to the interior portion of the zerk grease fitting 11, and extends so that the interior opening or end 16 of the tube 13 is in close proximity to the bearing rolling elements 14 to be lubricated.

The grease moves through the tube 13 in the direction of the arrow 17.

Preferably, but not necessarily, the end 16 of the tube 13 will emit grease at approximately 90 degrees to the face of the bearing elements 14.

The tube 13 may be fabricated from any suitable material. Preferably, but not necessarily, the tube 13 may be fabricated from plastic, and wherein the plastic tube 13 is glued or otherwise affixed to the interior portion 15 of the zerk grease fitting 11.

In an actual embodiment and test of the present invention, an 1100 horsepower motor which traditionally calls for 160 grams of grease per year in each of its 6320 ball bearings (8.6″ diameter) was running dry, with a consequent high noise level. Using the device and technique of the present invention, the bearing was brought to a constantly quiet state with only 2 grams of grease. Each shot of grease lowered the noise level, but due to its very dry state and size, 4 grams of extra lubricant were injected to guarantee the coating of all surfaces.

By using the technique of the present invention once a month, lubrication deficiencies can be avoided with only one or two shots of grease, thus lengthening the life of the roller bearing elements 14. The total grease usage for the bearing of the 1100 horsepower motor described hereinabove will then be 11 to 22 grams of grease per year, with defined results, compared to 160 grams of grease, which, due to a poor grease path design, has no guarantee of reaching the roller bearing elements 14.

The efficiency and effectiveness of the present invention was confirmed using sonic detection to listen to the bearing noise levels which determines whether the correct amount of grease has been used.

The significance and impact of the present invention on rotating equipment is: guaranteed lubrication accuracy; extended equipment life; less grease and costs; and reduction in breakdown and repairs resulting in overall cost savings.

There has been illustrated in the accompanying drawing and described hereinabove only one preferred embodiment of the present invention which can be constructed and configured in several different sizes, shapes, and arrangements for various types of rotating equipment.

It should be understood that many changes, modifications, variations, and other uses and applications will become apparent to those persons skilled in this particular area of technology and to others after having been exposed to the present patent application and accompanying patent drawing.

Any and all such changes, modifications, variations and other uses and applications which do not depart from the spirit and scope of the present invention are therefore covered by and embraced within the present invention and patent application.

1. A lubricating device for delivering fresh grease to a rolling element bearing in a first cavity, comprising:
means for by-passing all existing grease in said first cavity and in other cavities surrounding and/or leading to said rolling element bearing, and for delivering fresh grease in close proximity to said rolling element bearing.

2. A lubricating device according to claim 1, including:
a zerk grease fitting in fluid communication with one or more of said cavities; and
said means includes a tube leading from said zerk grease fitting to said rolling element bearing.

3. A lubricating device according to claim 1, wherein:
said means includes a tube which is affixed to the interior portion of a zerk grease fitting.

4. A lubricating device according to claim 2, wherein:
said means includes a tube which is affixed to the interior portion of said zerk grease fitting.

5. A lubricating device according to claim 1, wherein:
said means includes a tube which is affixed to the interior portion of a zerk grease fitting, and extends so that said interior opening or end of said tube is in close proximity to said rolling element bearing to be lubricated.

6. A lubricating device according to claim 2, wherein:
said tube is affixed to the interior portion of said zerk grease fitting, and extends so that the interior opening or end of said tube is in close proximity to said rolling element bearing to be lubricated.

7. A lubricating device according to claim 3, wherein:
said tube extends so that the interior opening or end of said tube is in close proximity to said rolling element bearing to be lubricated.

8. A lubricating device according to claim 1, wherein:
said means includes a tube which is affixed to the interior portion of said zerk grease fitting and extends so that the interior opening or end of said tube is in close proximity to said rolling element bearing to be lubricated; and
said end of said tube emits grease at approximately 90° to the face of said rolling element bearing to be lubricated.

9. A lubricating device according to claim 2, wherein:
said tube is affixed to the interior portion of said zerk grease fitting and extends so that the interior opening or end of said tube is in close proximity to said rolling element bearing to be lubricated; and
said end of said tube emits grease at approximately 90° to the face of said rolling element bearing to be lubricated.

10. A lubricating device according to claim 3, wherein:
said tube extends so that the interior opening or end of said tube is in close proximity to said rolling element bearing to be lubricated; and
said end of said tube emits grease at approximately 90° to the face of said rolling element bearing to be lubricated.

11. A lubricating device according to claim 4, wherein:
said tube extends so that the interior opening or end of said tube is in close proximity to said rolling element bearing to be lubricated; and
said end of said tube emits grease at approximately 90° to the face of said rolling element bearing to be lubricated.

12. A lubricating device according to claim 1, wherein:
said means includes a tube which is affixed to the interior portion of a zerk grease fitting; and
said tube is fabricated from plastic and wherein said plastic tube is glued or otherwise affixed to the interior portion of said zerk grease fitting.

13. A lubricating device according to claim 2, wherein:
said tube is affixed to the interior portion of said zerk grease fitting; and
said tube is fabricated from plastic and wherein said plastic tube is glued or otherwise affixed to said interior portion of said zerk grease fitting.

14. A lubricating device according to claim 3, wherein:
said tube is fabricated from plastic and wherein said plastic tube is glued or otherwise affixed to said interior portion of said zerk grease fitting.

15. A lubricating device according to claim 4, wherein:
said tube is fabricated from plastic and wherein said plastic tube is glued or otherwise affixed to said interior portion of said zerk grease fitting.

16. A lubricating device according to claim 5, wherein:
said tube is fabricated from plastic and wherein said plastic tube is glued or otherwise affixed to said interior portion of said zerk grease fitting.

17. A lubricating device according to claim 1, wherein:
said means guarantees that each shot of fresh grease reaches said rolling element bearing to be lubricated.

18. A lubricating device according to claim 1, wherein:
said means guarantees that every shot of fresh grease applied is injected directly into said rolling element bearing to be lubricated.

19. A lubricating device according to claim 1, wherein:
said means guarantees lubrication accuracy, extends equipment life, reduces the amount of grease and cost involved, and reduces breakdown and repairs from any improperly lubricated rolling element bearing.

20. A method for delivering fresh grease to a rolling element bearing in a first cavity, comprising the steps of:
by-passing all existing grease in said first cavity and in other cavities surrounding and/or leading to said rolling element bearing; and
delivering fresh grease in close proximity to said rolling element bearing.
